(19) United States
(12) Patent Application Publication
(10) Pub. No.: US 2025/0327591 A1
(43) Pub. Date: Oct. 23, 2025

(54) AIR PURIFIER

(71) Applicant: Shenzhen Beibanqiu Network Technology Co., Ltd., Shenzhen (CN)

(72) Inventors: Jin LI, Shenzhen (CN); Zhihai TANG, Shenzhen (CN); Weiwei XU, Shenzhen (CN)

(73) Assignee: Shenzhen Beibanqiu Network Technology Co., Ltd., Shenzhen (CN)

(21) Appl. No.: 19/257,409

(22) Filed: Jul. 1, 2025

(30) Foreign Application Priority Data
Jun. 11, 2025 (CN) 202521196056.9

(51) Int. Cl. F24F 8/108; B01D 24/46; F24F 8/90

(52) U.S. Cl. CPC F24F 8/108; B01D 24/461; F24F 8/90

(57) ABSTRACT

An air purifier comprises: a columnar hollow filter, a fan, an impurity scraping member and an impurity accommodation member. The fan starts and then draws external air through a sidewall of the columnar hollow filter into its cavity, the air is filtered and purified as it passes through the columnar hollow filter, thereby discharging clean air. Impurities attached to the air are accumulated on a surface of the columnar hollow filter; when the impurities accumulated on the surface of the columnar hollow filter reach a certain amount, the columnar hollow filter moves relative to the impurity scraping member, the impurity scraping member scrapes off the impurities from the surface of the columnar hollow filter into an accommodation chamber of the impurity accommodation member. The impurity accommodation member can temporarily store the impurities, thereby improve filtration quality of the air purifier and reduce replacement frequency of the filter element.

### RELATED APPLICATIONS

The present patent document claims the benefit of priority to patent application No. 202521196056.9, filed Jun. 11, 2025, and entitled “AIR PURIFIER,” the entire contents of each of which are incorporated herein by reference.

### 1. TECHNICAL FIELD

The present invention relates to the technical field of air purifiers, and particularly relates to an air purifier.

### 2. BACKGROUND INFORMATION

An air purifier is a device capable of improving indoor air quality. Through various technical means such as filtration and adsorption, the air purifier can effectively remove visible contaminants from air to provide fresh and healthy air for people, which helps alleviate allergic symptoms, prevent respiratory diseases, and protect human health. Especially in places with serious air pollution or special environmental requirements, the air purifier plays a vital role.

A surface of a filter element of the air purifier is prone to adsorb pet hair and dust, among which the pet hair is prone to clog air inlets on the surface of the filter element, reducing the filtration capacity of the air purifier. Users need to frequently remove the hair from the surface of the filter element or replace the filter element. As a result, the user experience needs to be improved.

### BRIEF SUMMARY

In order to overcome the shortcomings of the existing technology, the present invention provides an air purifier that can improve the user experience.

The technical solution adopted by the present invention to solve its technical problems is as follows:

An air purifier comprises:
a columnar hollow filter, wherein the columnar hollow filter includes opposing first end and second end along its axis direction;
a fan, which is arranged on the first end and configured to draw external air from a sidewall of the columnar hollow filter into a cavity of the columnar hollow filter;
an impurity scraping member, which moves relative to the columnar hollow filter and is configured to scrape off impurities attached on the sidewall of the columnar hollow filter; and
an impurity accommodation member, which is fixedly located relative to the impurity scraping member, and moves relative to the columnar hollow filter; wherein the impurity accommodation member is provided with an accommodation chamber, an impurity inlet is provided on a side of the impurity accommodation member that is opposite to a movement direction of the columnar hollow filter, and the impurities scraped off by the impurity scraping member are accumulated and stored in the accommodation chamber through the impurity inlet.

The air purifier as described above, the air purifier further comprises a housing, which is provided with multiple air inlets. The fan and the columnar hollow filter are arranged in the housing, and the impurity scraping member and the impurity accommodation member are both fixed on an inner wall of the housing.

The air purifier as described above, the air purifier further comprises a driving member drivingly connected to the second end; the driving member is configured to drive the columnar hollow filter to rotate relative to the impurity scraping member and the impurity accommodation member.

The air purifier as described above, a wiping member that has deformability is arranged on the impurity scraping member, at least one contact line is located between the wiping member and a surface of the columnar hollow filter, and the contact line is parallel to the axis direction of the columnar hollow filter.

The air purifier as described above, the impurity scraping member and the impurity accommodation member are fixedly connected to each other, and are both detachably connected to the housing.

The air purifier as described above, the housing is provided with a slot, which is parallel to the axis direction of the columnar hollow filter; and the impurity scraping member and the impurity collection chamber are both engaged with the slot.

The air purifier as described above, a radial cross-section of the columnar hollow filter is defined as a first surface.

On the first surface, the slot is formed by two L-shaped blocks fixed in the housing, the two L-shaped blocks are arranged opposite to each other to form the slot, and a notch width of the slot is defined as d. The impurity scraping member includes a first limiting block configured to engage with the slot, a first fixing block located outside the slot, and a connecting block connecting the first limiting block and the first fixing block. A width of the connecting block is less than or equal to d, and widths of the first limiting block and the first fixing block are greater than d, respectively.

The air purifier as described above, along the axis direction of the columnar hollow filter, the impurity accommodation member is provided with a rear end cover, and the rear end cover is configured to prevent spillage of the impurities of the accommodation chamber.

The air purifier as described above, the impurity scraping member and the impurity accommodation chamber are integrally formed.

The air purifier as described above, along the axis direction of the columnar hollow filter, lengths of the impurity scraping member and the impurity accommodation member are both greater than or equal to that of the columnar hollow filter, respectively.

The present invention has the following beneficial effects.

The fan starts and then draws external air through the sidewall of the columnar hollow filter 1 into the cavity of the columnar hollow filter; the air is filtered and purified as it passes through the columnar hollow filter element, thereby discharging clean air. Impurities attached to the air are accumulated on a surface of the columnar hollow filter, when the impurities accumulated on the surface of the columnar hollow filter reach a certain amount, the columnar hollow filter moves relative to the impurity scraping member, and the impurity scraping member scrapes off the impurities from the surface of the columnar hollow filter into the accommodation chamber of the impurity accommodation member. The impurity accommodation member can temporarily store the impurities, thereby improve the filtration quality of the air purifier and reduce the replacement frequency of the filter element.

### BRIEF DESCRIPTION OF THE DRAWINGS

The present invention is further illustrated below in combination with the accompanying drawings and embodiments.

FIG. 1 is a perspective schematic view of an air purifier in this embodiment.

FIG. 2 is a cross-sectional view taken along line A-A in FIG. 1.

FIG. 3 is a cross-sectional view taken along line B-B in FIG. 1.

FIG. 4 is an enlarged structural view of part B in FIG. 3.

FIG. 5 is a perspective schematic view of an impurity scraping member and an impurity accommodation member in this embodiment.

The reference numerals are as follows:
columnar hollow filter 1, sidewall 1a of the columnar hollow filter, cavity 1b of the columnar hollow filter, first end 11, second end 12, fan 2, impurity scraping member 3, first limiting block 31, first fixing block 32, connecting block 33, impurity accommodation member 4, accommodation chamber 41, impurity inlet 42, rear end cover 43, housing 5, air inlet 51, L-shaped block 521, slot 52, driving member 6, wiping member 7.

### DETAILED DESCRIPTION OF THE DRAWINGS AND THE PRESENTLY PREFERRED EMBODIMENTS

The conception, specific structure, and technical effects of the present invention will be clearly and completely illustrated below in conjunction with embodiments and accompanying drawings, so as to fully understand the objectives, features, and advantages of the present invention. Apparently, the described embodiments are merely a part of the embodiments of the present invention, but not all of the embodiments. Based on the embodiments of the present invention, all other embodiments obtained by those of ordinary skill in the art without exerting creative efforts shall fall within the protection scope of the present invention. Additionally, all connection or coupling relationships involved in the patent do not mean that components are directly connected, but that a better connection structure can be formed by adding or reducing the connection accessories according to the specific embodiments. Each technical feature in the creation of the present invention can be combined interactively without conflicting with each other.

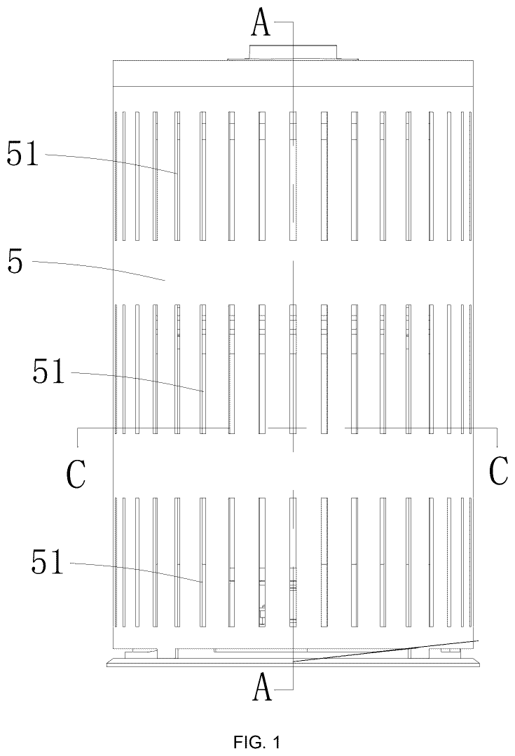

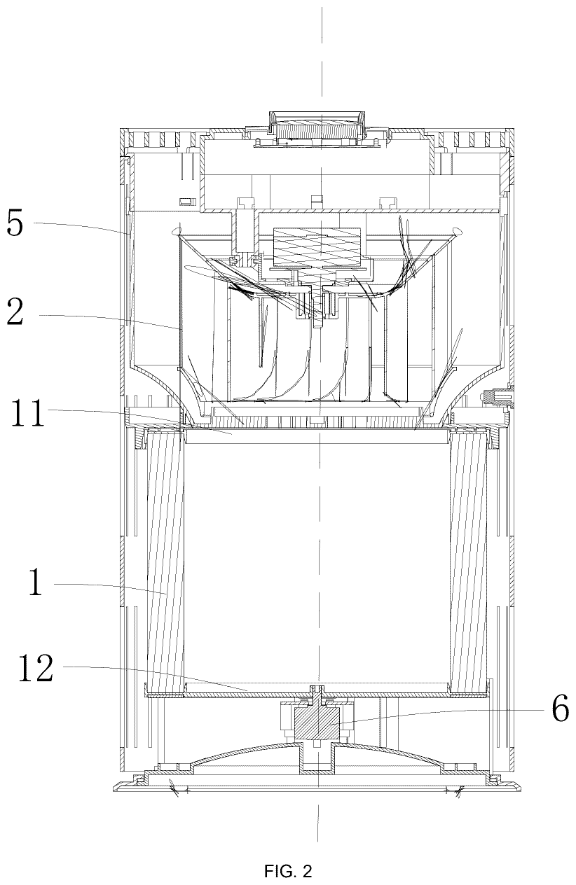

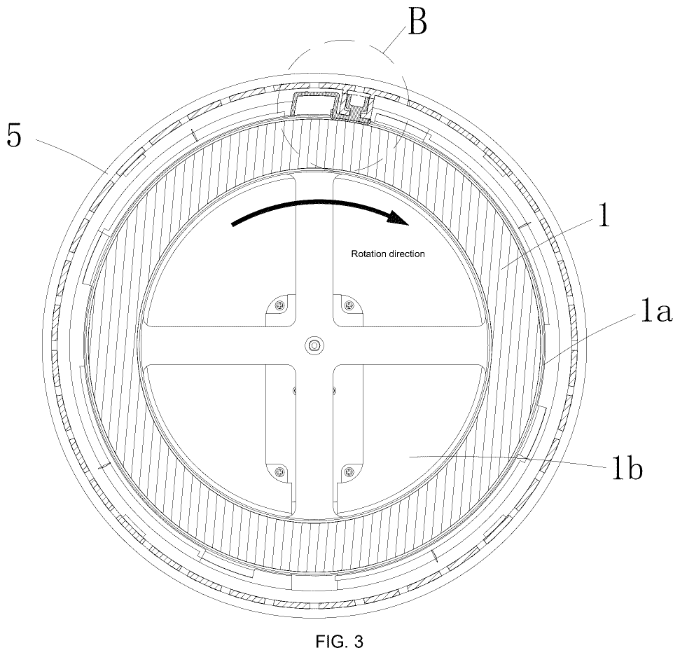

Referring to FIGS. 1-5, an air purifier comprises a columnar hollow filter 1, a fan 2, an impurity scraping member 3 and an impurity accommodation member 4. Along an axis direction of the columnar hollow filter 1, the columnar hollow filter 1 includes a first end 11 and a second end 12 arranged opposite to each other.

The fan 2 is arranged on the first end 11 to draw external air through a sidewall 1a of the columnar hollow filter 1 into a cavity 1b in the columnar hollow filter 1.

The impurity scraping member 3 moves relative to the columnar hollow filter 1 to scrape off the impurities attached to the sidewall 1a of the columnar hollow filter 1.

The impurity accommodation member 4 is fixed relative to the impurity scraping member 3, and moves relative to the columnar hollow filter 1. The impurity accommodation member 4 is provided with an accommodation chamber 41, and an impurity inlet 42 is provided on a side of the impurity accommodation member 4 opposite to the movement direction of the columnar hollow filter 1. The impurities scraped off by the impurity scraping member 3 are accumulated and stored in the accommodation chamber 41.

The working principle in this embodiment is as follow: the fan 2 starts and then draws external air through the sidewall 1a of the columnar hollow filter 1 into the cavity 1b of the columnar hollow filter 1; the air is filtered and purified as it passes through the columnar hollow filter element, thereby discharging clean air. Impurities attached to the air are accumulated on a surface of the columnar hollow filter 1, when the impurities accumulated on the surface of the columnar hollow filter 1 reach a certain amount, the columnar hollow filter 1 moves relative to the impurity scraping member 3, and the impurity scraping member 3 scrapes off the impurities from the surface of the columnar hollow filter 1 into the accommodation chamber 4 of the impurity accommodation member 41. The impurity accommodation member 4 can temporarily store the impurities, thereby improve the filtration quality of the air purifier and reduce the replacement frequency of the filter element.

Specifically, the air purifier in this embodiment can be used to filter the pet hair. As the pet hair is prone to clog the air inlets on the surface of the filter element, thereby reducing the filtration capacity of the air purifier, the air purifier in this embodiment can solve the technical problem that users need to frequently remove the pet hair from the surface of the filter element.

Specifically, in this embodiment, there are two kinds of movement modes of the columnar hollow filter 1 relative to the impurity scraping member 3 and the impurity accommodation member 4: one is that the columnar hollow filter 1 remains stationary, the impurity scraping member 3 and the impurity accommodation member 4 move around a circumferential side of the columnar hollow filter 1; the other is that the columnar hollow filter 1 rotates about its axis, and the impurity scraping member 3 and the impurity accommodation member 4 remain stationary.

Specifically, the columnar hollow filter 1 is configured as a hollow columnar shape.

More specifically, in order to optimize the filtration effect and improve the filtration quality, an outer diameter of the fan 2 is equal to an aperture of the first end 11, that is, the air discharged by the fan 2 entirely flows in through the sidewall 1a of the columnar hollow filter 1 and is filtered through the columnar hollow filter 1, thereby improving the filtration quality and reducing the impurity content in the filtered air.

In one embodiment, the second end 12 is in a closed state without connection to external environment, that is, the columnar hollow filter 1 has only one opening located at the first end 11.

In one embodiment, the air purifier further comprises a housing 5, which is provided with a plurality of air inlets 51. The fan 2 and the columnar hollow filter 1 are arranged in the housing 5, the impurity scraping member 3 and the impurity accommodation member 4 are both fixed to an inner wall of the housing 5.

The housing 5 serves as a connection structure to fix the relative positional relationships among the fan 2, the columnar hollow filter 1, the impurity scraping member 3, and the impurity accommodation member 4, preventing changes in the positional relationships between these components. In this embodiment, the housing 5 rotates to drive the impurity scraping member 3 and the impurity accommodation member 4 to scrape off the impurities from the surface of the columnar hollow filter 1. Alternatively, the columnar hollow filter 1 rotates, allowing the impurity scraping member 3 and the impurity accommodation member 4 to scrape off the impurities attached to its surface.

Specifically, the air inlets 51 are evenly distributed on the housing 5, the air evenly enters its cavity along the circumferential side of the columnar hollow filter 1, and the impurities are evenly attached to an outer side of the columnar hollow filter 1, preventing local insufficient cleaning when cleaning the columnar hollow filter 1.

In one embodiment, the air purifier further comprises a driving member 6 drivingly connected to the second end 12. The driving member 6 is configured to drive the columnar hollow filter 1 to rotate relative to the impurity scraping member 3 and the impurity accommodation member 4.

It should be understood that a rotational speed of the columnar hollow filter 1 relative to the impurity scraping member 3 is equal to the rotational speed of the columnar hollow filter 1 relative to the impurity accommodation member 4.

Specifically, an output end of the driving member 6 is connected to an axis of the columnar hollow filter 1, driving the columnar hollow filter 1 to rotate about its own axis.

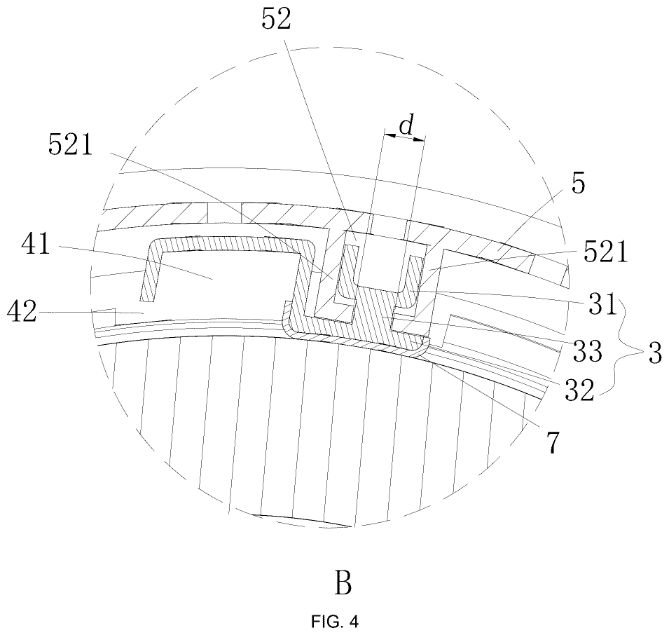

Referring to FIG. 4, in one embodiment, the impurity scraping member 3 is provided with a wiping member 7 that has deformability. The wiping member 7 has at least one contact line with the surface of the columnar hollow filter 1, and the contact line is parallel to an axial line of the columnar hollow filter 1.

In this embodiment, the contact method and orientation between the wiping member 7 and the surface of the columnar hollow filter 1 are defined, which ensures that after the wiping member 7 scrapes off the impurities, the impurities can enter the accommodation chamber 41 through the impurity inlet 42 as the columnar hollow filter 1 rotates.

It should be understood that, when the contact method between the wiping member 7 and the surface of the columnar hollow filter 1 is a surface contact, it means that there are multiple contact lines between the wiping member 7 and the surface of the columnar hollow filter 1.

Specifically, the wiping member 7 is configured as a brush.

In one embodiment, the impurity scraping member 3 is fixedly connected to the impurity accommodation member 4, and the impurity scraping member 3 and the impurity accommodation member 4 are both detachably connected to the housing 5.

When the impurity accommodation member 4 has collected a sufficient quantity of impurities and the accommodation chamber 41 is completely filled, the impurity accommodation member 4 shall be detached from the housing 5. After the accommodation chamber 41 is cleaned, the accommodation member 4 is reinstalled onto the housing 5.

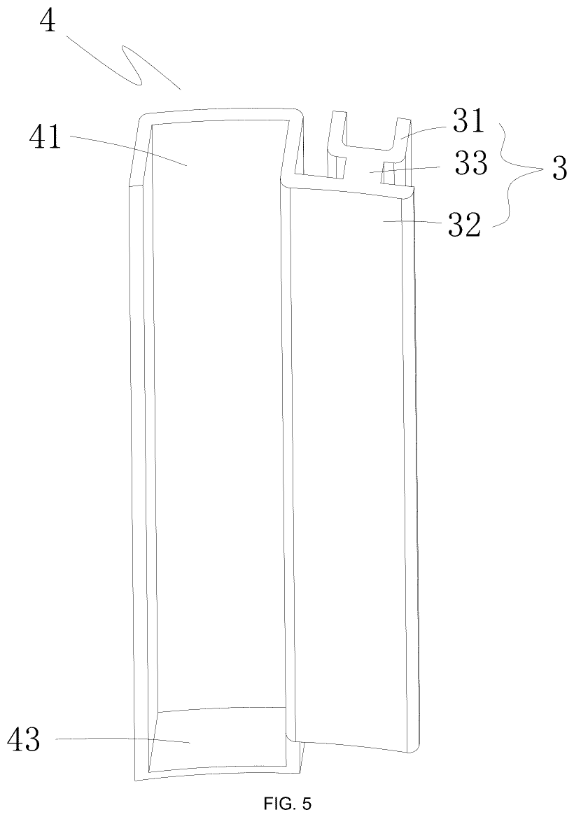

Referring to FIGS. 4-5, in one embodiment, the impurity scraping member 3 and the impurity accommodation member 4 are integrally formed.

In one embodiment, the housing 5 is provided with a slot 52, which is parallel to the axis line of the columnar hollow filter 1. The impurity scraping member 3 and the impurity accommodation member 4 are engaged with the slot 52.

Due to the integrated design of the impurity scraping member 3 and the impurity accommodation member 4, the impurity scraping member 3 can be extracted from the slot 52 along a longitudinal direction of the slot 52.

Referring to FIG. 4, in one embodiment, a radial cross-section of the columnar hollow filter element 1 is defined as a first surface.

On the first surface, the slot 52 is formed by two L-shaped blocks 521 fixed in the housing 5. The two L-shaped blocks are arranged opposite to each other to form the slot 52, and a notch width of the slot 52 is defined as d. The impurity scraping member 3 includes a first limiting block 31 configured to engage with the slot 52, a first fixing block 32 located outside the slot 52, and a connecting block 33 connecting the first limiting block 31 and the first fixing block 32. A width of the connecting block 33 is less than or equal to d, and widths of the first limiting block 31 and the first fixing block 32 are greater than d.

In one embodiment, along an axial direction of the columnar hollow filter 1, the impurity accommodation member 4 is provided with a rear end cover 43. The rear end cover 43 is configured to prevent spillage of the impurities of the accommodation chamber 41.

In one embodiment, along the axis direction of the columnar hollow filter 1, the lengths of the impurity scraping member 3 and the impurity accommodation member 4 are both greater than or equal to that of the columnar hollow filter 1, so as to cover the length of the columnar hollow filter 1, thus to ensure that the impurity scraping member 3 can be completely in contact with the columnar hollow filter 1.

The above provides detailed descriptions of preferred embodiments of the present invention. However, the scope of the present invention is not limited to the described embodiments. Those skilled in the art can make various equivalent modifications or substitutions without departing from the spirits of the present invention, and all such equivalent modifications or substitutions shall fall within the scope defined by the claims of the present invention.

1. An air purifier, comprising:
a columnar hollow filter, wherein along its axis direction, the columnar hollow filter includes a first end and a second end arranged opposite to each other;
a fan, which is arranged on the first end and configured to draw external air from a sidewall of the columnar hollow filter into a cavity of the columnar hollow filter;
an impurity scraping member, which moves relative to the columnar hollow filter and is configured to scrape off impurities attached on the sidewall of the columnar hollow filter; and
an impurity accommodation member, which is fixedly located relative to the impurity scraping member, and moves relative to the columnar hollow filter; wherein the impurity accommodation member is provided with an accommodation chamber, an impurity inlet is provided on a side of the impurity accommodation member that is opposite to a movement direction of the columnar hollow filter, and the impurities scraped off by the impurity scraping member are accumulated and stored in the accommodation chamber through the impurity inlet.

2. The air purifier according to claim 1, wherein an outer diameter of the fan is equal to an aperture of the first end.

3. The air purifier according to claim 1, the second end is in a closed state without connection to external environment.

4. The air purifier according to claim 1, wherein the air purifier further comprises a housing, multiple air inlets are provided on the housing, the fan and the columnar hollow filter are arranged in the housing, and the impurity scraping member and the impurity accommodation member are both fixed on an inner wall of the housing.

5. The air purifier according to claim 1, wherein the air purifier further comprises a driving member drivingly connected to the second end, the driving member is configured to drive the columnar hollow filter to rotate relative to the impurity scraping member and the impurity accommodation member.

6. The air purifier according to claim 1, wherein a wiping member that has deformability is arranged on the impurity scraping member 1, at least one contact line is located between the wiping member and a surface of the columnar hollow filter, and the contact line is parallel to the axis direction of the columnar hollow filter.

7. The air purifier according to claim 4, wherein the impurity scraping member and the impurity accommodation member are fixedly connected to each other, and are both detachably connected to the housing.

8. The air purifier according to claim 7, wherein the housing is provided with a slot, which is parallel to the axis direction of the columnar hollow filter; and the impurity scraping member and the impurity accommodation member are both engaged with the slot.

9. The air purifier according to claim 8, wherein a radial cross-section of the columnar hollow filter is defined as a first surface;
on the first surface, the slot is formed by two L-shaped blocks fixed in the housing, the two L-shaped blocks are arranged opposite to each other to form the slot, and a notch width of the slot is defined as d; the impurity scraping member includes a first limiting block configured to engage with the slot, a first fixing block located outside the slot, and a connecting block connecting the first limiting block and the first fixing block; a width of the connecting block is less than or equal to d, and widths of the first limiting block and the first fixing block are greater than d, respectively.

10. The air purifier according to claim 9, wherein along the axis direction of the columnar hollow filter, the impurity accommodation member is provided with a rear end cover, and the rear end cover is configured to prevent spillage of the impurities within the accommodation chamber.

11. The air purifier according to claim 10, wherein the impurity scraping member and the impurity accommodation chamber are integrally formed.

12. The air purifier according to claim 1, wherein along the axis direction of the columnar hollow filter, lengths of the impurity scraping member and the impurity accommodation member are both greater than or equal to that of the columnar hollow filter, respectively.
